(19) United States
(12) Patent Application Publication
(10) Pub. No.: US 2026/0208191 A1
(43) Pub. Date: Jul. 23, 2026

(54) MICROFLUIDIC DEVICE AND METHOD FOR FORMING A CELL ASSEMBLY, AND METHOD FOR SELECTIVELY TREATING A CELL WITHIN SUCH A CELL ASSEMBLY

(71) Applicants: CENTRE NATIONAL DE LA RECHERCHE SCIENTIFIQUE (CNRS), PARIS (FR); CENTRE HOSPITALIER UNIVERSITAIRE DE LILLE, LILLE (FR); INSTITUT NATIONAL DE LA SANTE ET DE LA RECHERCHE MEDICALE, PARIS (FR); UNIVERSITE DE LILLE, LILLE (FR); JUNIA, LILLE CEDEX (FR)

(72) Inventors: Dominique COLLARD, LAMBERSART (FR); Carine BRINSTER, MARQUETTE LEZ LILLE (FR); Loïc LEMONNIER, LILLE (FR); Bruno QUESNEL, LILLE (FR); Mehmet Cagatay TARHAN, LAMBERSART (FR); Yasmine TOUIL, LILLE (FR); Shaik FARUK AZAM, LILLE (FR)

(73) Assignees: CENTRE NATIONAL DE LA RECHERCHE SCIENTIFIQUE (CNRS), PARIS (FR); CENTRE HOSPITALIER UNIVERSITAIRE DE LILLE, LILLE (FR); INSTITUT NATIONAL DE LA SANTE ET DE LA RECHERCHE MEDICALE, PARIS (FR); UNIVERSITE DE LILLE, LILLE (FR); JUNIA, LILLE CEDEX (FR)

(21) Appl. No.: 19/157,129

(22) PCT Filed: Feb. 15, 2024
(86) PCT No.: PCT/EP2024/053904

§ 371 Date: Aug. 15, 2025

(30) Foreign Application Priority Data
Feb. 15, 2023 (EP) 23305199.4
Apr. 26, 2023 (EP) 23170111.1

(51) Int. Cl. B01L 3/00

(52) U.S. Cl. CPC B01L 3/502761; B01L 2200/0668; B01L 2300/0645; B01L 2300/0681; B01L 2400/0418; B01L 2400/0424; B01L 2400/06

(57) ABSTRACT

The invention relates to a microfluidic device (1) for forming a cell assembly comprising at least one first cell (C1) and one second cell (C2) and for individually treating a selected cell of said cell assembly, comprising: —a microfluidic channel (10); —at least one main inlet (11) for a fluid containing first cells, respectively second cells, arranged in a first portion (101) of the microfluidic channel; —an outlet (12) arranged in a second portion (102) of the microfluidic channel for controlling a fluid flow rate in the microfluidic channel; —at least one first auxiliary inlet (131) for a first auxiliary fluid arranged in the first portion (101) of the microfluidic channel upstream or downstream of the main inlet (11); —at least one cell trap (14) arranged in the microfluidic channel between the first portion and the second portion, wherein each cell trap (14) comprises at least one first trapping portion (141) and one second trapping portion (142), each first and second trapping portion being sized to receive a respective first or second cell, said first and second trapping portions being adjacent to each other in a direction perpendicular to a bottom (100) of the microfluidic channel to form the cell assembly with the trapped first and second cells, each cell being at a different height relative to the bottom of the microfluidic channel, —at least one first valve for controlling a flow rate of the first auxiliary fluid so as to cause the fluid containing the first cells, respectively the second cells, to flow at a determined height in the microfluidic channel in order to bring the first cell, respectively the second cell, to the first trapping portion, respectively to the second trapping portion.

### FIELD OF THE INVENTION

The present invention relates to a microfluidic device and a method for forming a cell assembly, and a method for selectively treating a cell within such a cell assembly.

### BACKGROUND OF THE INVENTION

Cell-cell interactions play a crucial role in various biological systems, and notably in immunity, where cell pairing initiates and mediates many critical developmental (selection, proliferation, differentiation) and functional (cytolysis, cytokine and antibody production) immune responses. In this context, a better understanding of interaction dynamics between immune cells and their cellular partners is fundamental.

Various microfluidic devices allowing trapping cells so as to form cell assemblies, such as cell pairs or cell triplets, have been described.

In particular, F₁₁.A. Shaik et al [1] have disclosed, as shown in FIG. 1, a microfluidic device comprising a microfluidic channel 10′, an inlet 11′ for a fluid containing cells, arranged in a first portion 101′ of the microfluidic channel, an outlet 12′ arranged in a second portion 102′ of the microfluidic channel for controlling a fluid flow rate in the microfluidic channel, and a trap 14′ arranged between the first and second portions to trap cells. The trap comprises first and second trapping portions 141′, 142′. The first, lower trapping portion 141′, has a width and height relative to the bottom 100′ of the microfluidic channel sized to retain a small cell, and the second, upper trapping portion 142′, has a width and height relative to the bottom 100′ of the microfluidic channel sized to retain a larger cell. In a first step (i), a solution containing small cells C1 is introduced in the microfluidic channel through the first inlet (on the left of the figure, not shown), and an auxiliary fluid is introduced in the microfluidic channel through a second inlet 13′ so as to cause the solution to flow along the bottom 100′ of the microfluidic channel. As a result, a small cell can be trapped in the first, lower trapping portion. In a second step (ii), the flow rate of the auxiliary fluid is increased to withdraw the solution containing the small cells. In a third step (iii), a solution containing larger cells C2 is introduced in the microfluidic channel through the first inlet. In this step, the second inlet is closed and no auxiliary fluid flows within the microfluidic channel. A larger cell can thus be retained by the second, upper trapping portion 142′, in contact with the small cell C1 retained by the first, lower trapping portion 141′. A horizontal (i.e. parallel to the bottom 100′ of the microfluidic channel) cell pair is thus formed by the small and large cells C1, C2.

However, there remains a need to treat the cells with specific agents to determine the behaviour of each type of cell.

This selective treatment cannot be achieved with the microfluidic device illustrated in FIG. 1 since both cells would be exposed to an agent flowing in the microfluidic channel.

### SUMMARY OF THE INVENTION

A goal of the invention is thus to provide a microfluidic device allowing constructing a wider range of cell assemblies and selectively treating one cell of the assembly with a respective agent.

To that end, the invention provides a microfluidic device for forming a cell assembly comprising at least one first cell and one second cell and for individually treating a selected cell of said cell assembly, comprising:
a microfluidic channel;
at least one main inlet for a fluid containing first cells, respectively second cells, arranged in a first portion of the microfluidic channel;
an outlet arranged in a second portion of the microfluidic channel for controlling a fluid flow rate in the microfluidic channel;
at least one first auxiliary inlet for a first auxiliary fluid arranged in the first portion of the microfluidic channel upstream or downstream of the main inlet;
at least one cell trap arranged in the microfluidic channel between the first portion and the second portion,
wherein each cell trap comprises at least one first trapping portion and one second trapping portion, each first and second trapping portion being sized to receive a respective first or second cell, said first and second trapping portions being adjacent to each other in a direction perpendicular to a bottom of the microfluidic channel to form the cell assembly with the trapped first and second cells, each cell being at a different height relative to the bottom of the microfluidic channel,
at least one first valve for controlling a flow rate of the first auxiliary fluid so as to cause the fluid containing the first cells, respectively the second cells, to flow at a determined height in the microfluidic channel in order to bring the first cell, respectively the second cell, to the first trapping portion, respectively to the second trapping portion.

According to a preferred embodiment, the microfluidic device further comprises at least one second auxiliary inlet for a second auxiliary fluid arranged in the first portion of the microfluidic channel and at least one second valve for controlling a flow rate of the second auxiliary fluid, the second auxiliary inlet being arranged relative to the main inlet and the first auxiliary inlet so as to cause the fluid containing the first or second cells to be pinched between the first and second auxiliary fluids.

Preferably, the main inlet, the first auxiliary inlet and, if appropriate, the second auxiliary inlet are arranged at different heights relative to the bottom of the microfluidic channel, said heights increasing along the flow direction.

The main inlet, the first auxiliary inlet and, if appropriate, the second auxiliary inlet, advantageously present a width substantially equal to a width of the microfluidic channel.

In some embodiments, the microfluidic device further comprises a filter arranged in the microfluidic channel between the first portion and the at least one cell trap.

In preferred embodiments, the microfluidic device comprises a plurality of cell traps in a staggered arrangement in the microfluidic channel.

In some embodiments, the first and second trapping portions of each cell trap have different sizes, in particular different heights.

In some embodiments, at least one trapping portion is configured to trap at least two cells of a same size.

Advantageously, at least one of the main inlet, first auxiliary inlet and, if appropriate, second auxiliary inlet is adapted to introduce a respective agent in the microfluidic channel, the at least one first valve, and, if appropriate, second valve being configured to cause said agent to flow at a determined height in the microfluidic channel in order to bring said agent selectively to the trapped first and/or second cell.

In some embodiments, the device further comprises an array of electrically isolated electrodes arranged on a bottom of the microfluidic channel such that an overlapping area of two electrodes is located under each trap, at least one surface of each electrode being exposed in a recess in said overlapping area, each electrode being connected to an electrical source so as to selectively apply a potential difference to the solution at each overlapping area.

In some embodiments, the device further comprises at least one pair of electrodes, the electrodes of each pair being electrically isolated from each other and arranged parallel to each other on a bottom of the microfluidic channel such that an area of the pair of electrodes is located under each trap, at least one surface of each electrode of the pair of electrodes being exposed in a recess formed around said area of the pair of electrodes, each electrode being connected to an electrical source so as to selectively apply a potential difference to the solution at each area of the pair of electrodes.

Another object of the invention is a method for forming a cell assembly using the above-described microfluidic device.

In the microfluidic device, the first trapping portion of each cell trap is sized to retain a first cell and the second trapping portion is sized to retain a second cell, each cell being at a different first, respectively second height relative to the bottom of the microfluidic channel.

The method comprises:
flowing a first solution comprising the first cell in the microfluidic channel,
causing said first solution to flow at a first height in the microfluidic channel using a flow of at least one auxiliary fluid, so as to bring the first cell to the first trapping portion,
flowing a second solution comprising the second cell in the microfluidic channel,
modifying the flow rate of the auxiliary flow to control said second solution to flow at a second height so as to bring the second cell to the second trapping portion.

In some embodiments, the method allows forming a cell assembly comprising at least three cells at in first, second and third trapping portions located at different first, second and third heights relative to the bottom of the microfluidic channel, using the microfluidic device which comprises the main inlet and the first and second auxiliary inlets. The method thus comprises:
flowing a first solution comprising the first cell in the microfluidic channel,
causing said first solution to flow at a first height in the microfluidic channel using a flow of the first auxiliary fluid, the second auxiliary inlet being closed, so as to bring the first cell to the first trapping portion,
flowing a second solution comprising the second cell in the microfluidic channel,
causing said second solution to flow at a second height in the microfluidic channel using a flow of the first auxiliary fluid and the second auxiliary fluid pinching the second solution, so as to bring the second cell to the second trapping portion;
flowing a third solution comprising the third cell,
causing said third solution to flow at a third height in the microfluidic channel using a flow of the second auxiliary fluid, the first auxiliary inlet being closed, so as to bring the third cell to the third trapping portion.

In some embodiments, the method comprises releasing a cell assembly from a selected trap by applying, to the electrodes overlapping under said trap, an electrical potential difference greater than an electrical potential difference triggering electrolysis, dielectrophoresis or electroosmosis of the solution in the respective recess, so as to generate a bubble adapted to push the cell assembly out of the trap.

In some embodiments, the method comprises releasing a cell assembly from a selected trap by applying, to the electrodes of a pair of electrodes under said trap, an electrical potential difference greater than an electrical potential difference triggering electrolysis, dielectrophoresis or electroosmosis of the solution in the respective recess, so as to generate a bubble adapted to push the cell assembly out of the trap.

Another object of the invention is a method for selectively treating a cell within a cell assembly using the above-described microfluidic device. Said method comprises:
forming the cell assembly with the method described above, the cell assembly comprising at least one first cell located at a first height and at least one second cell located at a second height, different from the first height, relative to the bottom of the microfluidic channel,
flowing an agent into the microfluidic channel though at least one of the main inlet, first inlet, or, if appropriate, second inlet,
flowing at least one auxiliary fluid introduced into the microfluidic channel through another one of the main inlet, first auxiliary inlet, or, if appropriate, second auxiliary inlet so as to cause said agent to flow at a controlled height in the microfluidic channel to bring said agent to a selected cell within the cell assembly.

In some embodiments, the method allows selectively treating the first and second cells of the cell assembly with respective first and second agents using the microfluidic device which comprises the main inlet and the first and second auxiliary inlets. Said method comprises:
flowing a buffer through the main inlet,
flowing the first agent through the first auxiliary inlet, the second auxiliary inlet being closed, so as to cause the first agent to flow at a first height in the microfluidic channel to bring said first agent to the first cell;
flowing the second agent through the second auxiliary inlet, the first auxiliary inlet being closed, so as to cause the second agent to flow at a second height in the microfluidic channel to bring said second agent to the second cell.

In other embodiments, the method for selectively treating the first and second cells of the cell assembly with respective first and second agents may comprise:
flowing a buffer through the main inlet,
flowing the first agent through the first auxiliary inlet and the second agent through the second auxiliary inlet, so as to concurrently cause the first agent to flow at a first height in the microfluidic channel to bring said agent to the first cell and cause the second agent to flow at a second height in the microfluidic channel to bring said second agent to the second cell.

Advantageously, at least one of the first and second agent has a determined pH and/or a determined viscosity, said pH or viscosity being chosen to simulate cell interaction in a determined situation.

The fields of application of the invention include the development of precision medicine for the treatment of cancer in tumor dormancy, the evaluation of candidate molecules to stimulate the immunological response and, more generally, the study of parallel cell-cell interactions for new drug discovery and/or precision drug development.

### BRIEF DESCRIPTION OF THE FIGURES

Further features and advantages of the invention will be presented in the following detailed description, based on the appended drawings, in which:

FIG. 1 schematically illustrates the trapping of two cells of different sizes with a microfluidic device according to prior art citation [1];

FIG. 2A is a general overview of the microfluidic device;

FIG. 2B is a top view of an embodiment of the microfluidic device;

FIG. 2C is a sectional view of an embodiment of the microfluidic device;

FIG. 3 that illustrates the results of FEM simulations for a microfluidic system with inlets at the same height or at increasing heights along the flow direction;

FIG. 4 is a cross-sectional view of the main, first auxiliary and second auxiliary fluids with different conditions of the flow rate at the first and second inlets and at the outlet;

FIG. 5 illustrates successive steps for forming a cell triplet with an embodiment of the microfluidic device;

FIG. 6 illustrates various trap designs allowing forming pairs or triplets of cells;

FIG. 7 schematically illustrates consecutive access to the two cells of a cell pair (top, middle) and simultaneous access to both cells (bottom) with an embodiment of the microfluidic device;

FIG. 8 illustrates a side view (left) and a cross-sectional view acquired by confocal microscopy of the flow of labeled microspheres injected through the main channel in the microfluidic channel (right) with flow conditions for consecutive access to individual cell types;

FIG. 9 illustrates a side view (left) and a cross-sectional view acquired by confocal microscopy of the flow of labeled microspheres injected through the main channel in the microfluidic channel (right) with flow conditions for simultaneous access to individual cell types;

FIG. 10 illustrates individual access to cell types performed either consecutively or concurrently;

FIG. 11 demonstrates a specific binding of the top cell of the assembly but not of the bottom cell of the assembly;

FIG. 12 schematically illustrates an embodiment of the device comprising an array of electrodes configured for generating a bubble in order to selectively retrieve a cell assembly from a trap;

FIGS. 13A-13C illustrate embodiments of the array of electrodes;

FIG. 14 schematically illustrates an embodiment of the device comprising pairs of electrodes parallel to each other configured for generating a bubble in order to selectively retrieve a cell assembly from a trap.

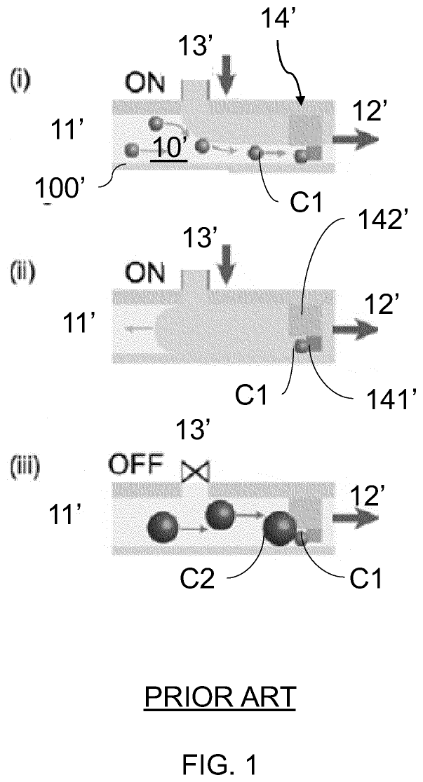

### DETAILED DESCRIPTION OF EMBODIMENTS

The microfluidic device is configured to both form a cell assembly by trapping at least one first cell and at least one second cell and then to individually access to a selected cell of said cell assembly.

### Microfluidic Device

The microfluidic device comprises a microfluidic channel adapted for flow of at least one fluid from a first end to a second end of the channel, opposite to the first end. The microfluidic channel comprises a bottom extending along a longitudinal direction of the channel, which is the direction of flow of the fluid, two parallel side walls extending in the longitudinal direction, perpendicular to the bottom, and a top parallel to the bottom. The distance between the side walls defines a width of the microfluidic channel. The distance between the bottom and the top defines a height of the microfluidic channel. The distance between the first and second ends defines a length of the microfluidic channel. In the present text, it is considered that the bottom is horizontal and the side walls are vertical.

The microfluidic device comprises at least one cell trap arranged between the first and second ends of the microfluidic channel and configured to trap cells flowing within the fluid to form the cell assembly. Preferably, the microfluidic device comprises a plurality of cell traps located in a trapping region of the microfluidic channel.

By “cell assembly” is meant in the present text an assembly of at least two cells that are in contact or sufficiently close to each other to allow physical and/or chemical interactions between said cells. A cell assembly formed of two cells is called “cell pair”; a cell assembly formed of three cells is called “cell triplet”. However, the number of cells is not limited and the cell assembly may be formed of more than three cells. In some embodiments, the cells may be of different types. In other embodiments, at least two cells of the cell assembly may be of the same type.

“Individually treating a cell” means in the present text selectively delivering an agent to a selected cell (or selected group of cells) of the cell assembly, without delivering said agent to at least one other cell of the cell assembly.

In the present text, an agent can be an antibody, a drug, such as a chemotherapy, specific cell signaling modulators, growth factors, ion channel modulators, a plurality of coated beads, staining agents, dyes, nanodots, nanoparticles, cells, including CAR-T and CAR-NK cells, etc.

To allow such an individual access, the trapped cells are stacked vertically in the trap, i.e. in a direction perpendicular to the bottom of the microfluidic channel.

Both placing of the cells at a given height of the trap and treating a given cell of the cell assembly can be achieved by a precise flow control within the microfluidic channel.

For such a flow control, the microfluidic device comprises at least one main inlet for a main fluid (e.g. a fluid containing first cells, respectively second cells), and at least one first auxiliary inlet for a first auxiliary fluid. The first auxiliary inlet is located upstream or downstream from the main inlet along the direction of the fluid flow.

Preferably, the microfluidic device further comprises at least one second auxiliary inlet for a second auxiliary fluid. Said second auxiliary inlet is located on the side of the main inlet opposite to the first auxiliary inlet. Otherwise said, the main inlet is arranged between the first and second auxiliary inlets along the longitudinal direction of the channel. The second auxiliary fluid may be the same as the first auxiliary fluid, or a different fluid.

The main inlet, first auxiliary inlet and, if any, second auxiliary inlet are located at the first end of the microfluidic channel.

Each inlet may be fluidically connected to a fluid container, or may present an opening accessible to a user to inject fluid directly in the microfluidic channel. As different fluids may be used to form the cell assembly and to treat an individual cell, such fluidic connection may be releasable in order to allow interchangeably connecting a respective inlet to different fluid containers at different stages of use of the microfluidic device.

The microfluidic device further comprises an outlet arranged at the second end of the microfluidic channel for controlling a fluid flow rate in the microfluidic channel.

To that end, the outlet may be provided with a pump that withdraw fluids from the microfluidic channel at a controlled rate.

The first and second auxiliary inlets are provided with a valve with a flow sensor allowing injecting the auxiliary fluid(s) at a controlled flow rate into the microfluidic channel. In some steps, the first or second auxiliary inlet may be closed.

The valves may be operated manually by an operator. Alternatively, the valves may be operated automatically by a processor that executes a program.

In order to allow creating a laminar flow of the fluids in the microfluidic channel, the inlets preferably have a width equal to the width of the microfluidic channel.

As will be explained in more detail below, the inlets may be arranged at different heights with respect to the bottom of the microfluidic channel.

The microfluidic device may advantageously comprise a filter arranged in the microfluidic channel between the inlets and the trapping region. Said filter allows preventing prevent clogging of the cell traps by aggregates and debris.

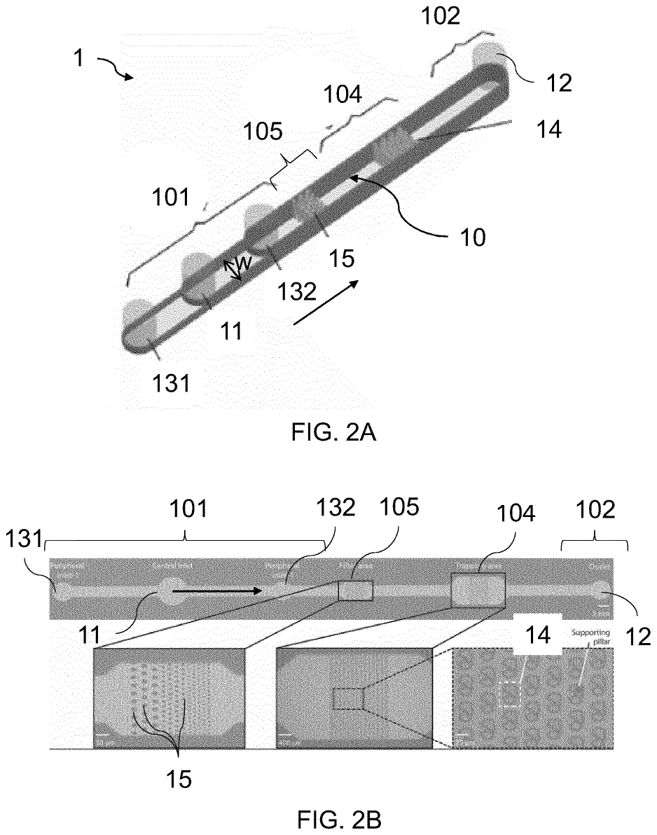

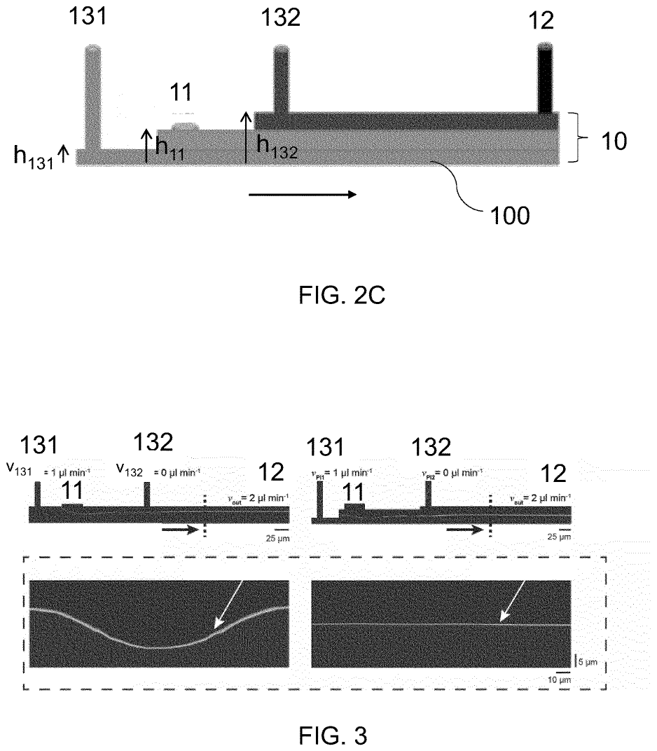

FIG. 2A is a schematic view of such a microfluidic device 1.

From the first end 101 to the second end 102 of the microfluidic channel, the device comprises a first auxiliary inlet 131, a main inlet 11, a second auxiliary inlet 132, a filter 105, a cell trapping region 104 and an outlet 12. The arrow indicates the flow direction.

FIG. 2B is a top view of an embodiment of the microfluidic device.

The filter 105 may be formed of a plurality of vertical pillars 15 extending from the bottom to the top of the microfluidic channel, arranged in staggered rows. The size of the pillars 15 and the distance between adjacent pillars along the width w of the microfluidic channel may vary along the longitudinal direction of the microfluidic channel. For example, on the inlet side, the pillars of one or several rows may be of a relatively large size (e.g. between 20 μm and 50 μm) and separated by a relatively large distance (e.g. 50 μm) so as to block large aggregates or debris, whereas on the outlet side, the pillars of one or several rows may be of a relatively small size (e.g. 10 μm) and separated by a relatively small distance (e.g. 20 μm) so as to block small aggregates and debris.

The shape of the pillars is designed so as not to disturb the fluid flow within the microfluidic channel. In particular, the pillars may have an oblong cross section.

The trapping region 104 may be formed of a plurality of cell traps 14 arranged in staggered rows in order to optimize trapping of the cells. Each cell trap comprises at least two trapping portions 141, 142 arranged vertically.

The trap geometry is adjusted according to target cell dimensions and assembly condition (single or multiple cells).

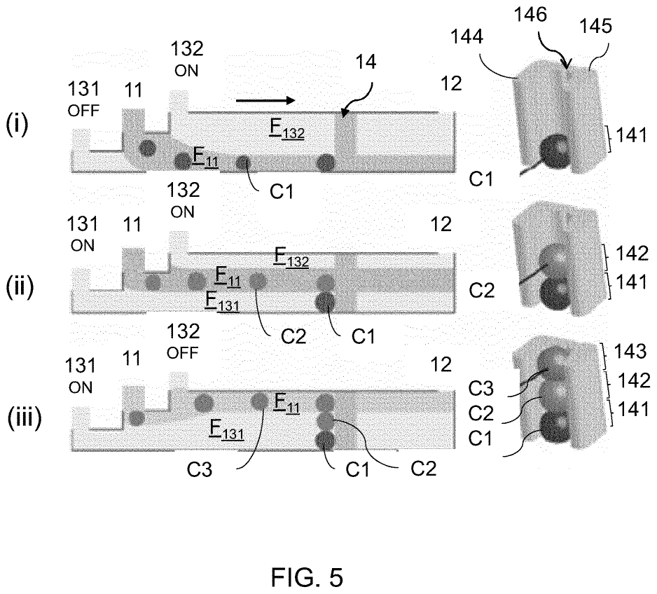

Each trap has two vertical side walls 144, 145 with a narrow opening 146 between them (see FIG. 5), the opening being narrower than the size of the cells so as to prevent a trapped cell from flowing through the opening.

Advantageously, the trap opening forms an angle with the flow direction, for example 450 for single-cell pairing and 300 for multiple-cell pairing. Such angled trap openings sustain higher flow rates in the channel without disturbing trapped cells for higher throughput.

The width (i.e. the inner distance between the vertical side walls) and height of the trapping portions are chosen based on the size of the cells to be trapped. Advantageously, the width of each trapping portion is slightly greater than the size of the cell to be trapped, so as to allow the cell to enter into the trap without constraining the cells. The height of each trapping portion is chosen to allow all the cells to be received in the trap while enabling interactions between the cells.

Since the cells to be assembled may be of different sizes, the width and height of the trapping portions may vary in the vertical direction. As a result, the side walls of the traps may not be planar in the vertical direction but may be provided with steps delimiting adjacent trapping portions.

### Control of the Flow

FIG. 2C shows a sectional view of a preferred embodiment of the microfluidic device.

In this embodiment, the main inlet 11 and the first and second auxiliary inlets 131, 132 are arranged at different heights h₁₁, h₁₃₁, h₁₃₂ from the bottom 100 of the microfluidic channel.

In particular, the first auxiliary inlet 131 which is arranged upstream of the main inlet 11 is arranged closer to the bottom 100 of the microfluidic channel, and the second auxiliary inlet 132 which is arranged downstream of the main inlet is arranged farther from the bottom 100 of the microfluidic channel.

Otherwise said, the first auxiliary inlet, the main inlet and the second auxiliary inlet are designed with their height relative to the bottom of the microfluidic channel in increasing order.

As compared to a design in which the first auxiliary inlet, the main inlet and the second auxiliary inlet are all located at the same height relative to the bottom of the microfluidic channel, the arrangement of FIG. 2C has the advantage of achieving a uniform flow profile in a plane perpendicular to the flow direction.

This technical effect can be easily seen in the comparative example of FIG. 3 that illustrates the results of FEM simulations for a microfluidic system with inlets at the same height or at increasing heights along the flow direction. The flow rate v₁₃₁ at the first auxiliary inlet 131, the flow rate v₁₃₂ at the second auxiliary inlet 132 and the flow rate V₁₂ at the outlet 12 are the same in configurations.

These simulations show, in a cross-sectional view of the microfluidic channel perpendicular to the flow direction, a non-uniform flow profile of the flow for inlets at the same height (left). Inlets at different heights (right), as demonstrated with the first auxiliary inlet 131 at 10 μm, the main inlet 11 at 30 μm, and the second auxiliary inlet 132 at 35 μm above the bottom of the microfluidic channel, provided a uniform cross-sectional profile.

The first and second auxiliary inlets can be used to control the main fluid flow and thereby creating a “virtual” channel to which the main fluid flow is constrained.

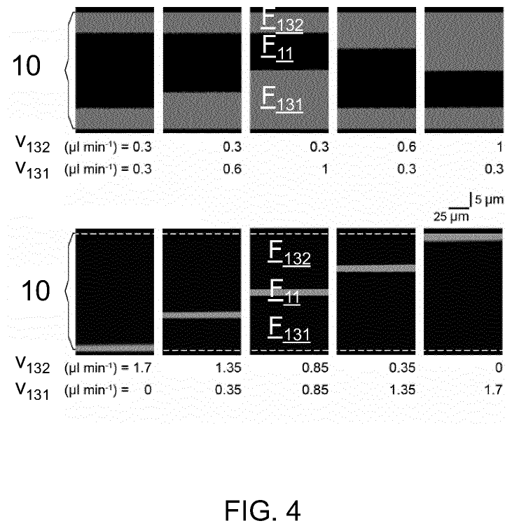

As shown in FIG. 4, which is a cross-sectional view of the main, first auxiliary and second auxiliary fluids F₁₁, F₁₃₁, F₁₃₂ in a direction perpendicular to the flow, this control can be made in terms of thickness of the main fluid flow F₁₁ in the vertical direction (top) and/or in terms of position of the main fluid flow F₁₁ in the vertical direction (bottom). In FIG. 4, various conditions of the flow rate at the first and second inlets are presented for a constant flow rate of 2 μl min⁻¹ at the outlet.

The thickness of the main flow can be adjusted based on the flow rate of the first and second auxiliary fluids relative to the flow rate at the outlet. The greater the flow rate at the outlet relative to the flow rate at the first and second auxiliary inlets, the greater the thickness of the main flow.

In addition, the position of the main flow can be adjusted based on the flow rate of the first auxiliary fluid relative to the flow rate of the second auxiliary fluid. The greater the flow rate at the first auxiliary inlet relative to the flow rate at the second auxiliary inlet, the higher the main flow relative to the bottom of the microfluidic channel.

It is thus possible to finely tune both the thickness and the height of the main flow by adjusting the flow rate at the first inlet, the second inlet and at the outlet.

In case the microfluidic device comprises only one auxiliary inlet, the thickness of the main flow may be controlled by adjusting the flow rate at the auxiliary inlet relative to the flow rate at the outlet. However, in the absence of a second auxiliary fluid flow, the main flow cannot be pinched between said auxiliary flows and its position in the vertical direction thus cannot be controlled.

The ratio between inlet flow rate and outlet flow rate defines the height of the created stacked flows, regardless of the physical height of the microfluidic channel.

This precise control of the flow of the main fluid and of the first and second auxiliary fluids allows assembly cells into a vertical stack and individually accessing to a cell within the assembly, as will be explained below.

### Formation of a Cell Assembly

To form a cell assembly, cells of each type are injected sequentially in a main fluid through the main inlet. For the injection of each cell type, the flow rate at each auxiliary inlet relative to the flow rate at the outlet is controlled to adjust the position—and, if appropriate, the thickness, of the main flow, so as to guide the cells to the intended trapping portion of the trap.

FIG. 5 schematically illustrates the formation of a cell assembly comprising three cells C1, C2, C3 stacked vertically. Each trap thus comprises three trapping portions 141, 142, 143 stacked vertically. In the example shown, the three cells have the same size and the three trapping portions also have the same size. However, the control of the flow rate of the first and second auxiliary fluids allows arranging each cell in a selected trapping portion.

For example, in a first step (i), a main fluid containing cells C1 of a first type is injected in the microfluidic channel through the main inlet 11. The first auxiliary inlet 131 is closed (OFF state) and an auxiliary fluid is injected through the second auxiliary inlet 132 (ON). The flow rate at the second auxiliary inlet is controlled to force the main fluid to flow in a bottom part of the microfluidic channel, thereby causing a cell of the first type to engage the bottom trapping portion 141 of each trap 14.

In a second step (ii), a main fluid containing cells C2 of a second type is injected in the microfluidic channel through the main inlet 11. First and second auxiliary fluids are injected through both the first auxiliary inlet 131 and the second auxiliary inlet 132. The flow rate at the first and second auxiliary inlet is controlled to force the main fluid to flow in a middle part of the microfluidic channel, thereby causing a cell of the second type to engage the middle trapping portion 142 of each trap 14.

In a third step (iii), a main fluid containing cells C3 of a third type is injected in the microfluidic channel through the main inlet 11. The second auxiliary inlet 132 is closed and an auxiliary fluid is injected through the first auxiliary inlet 131. The flow rate at the first auxiliary inlet is controlled to force the main fluid to flow in a top part of the microfluidic channel, thereby causing a cell C3 of the third type to engage the top trapping portion 143 of each trap 14.

Of course, the number and order of the steps is given only as an illustrative example and is not intended to limit the scope of the invention. The skilled person is able to define the number of auxiliary fluids and the flow rate of each auxiliary fluid to be a given cell assembly.

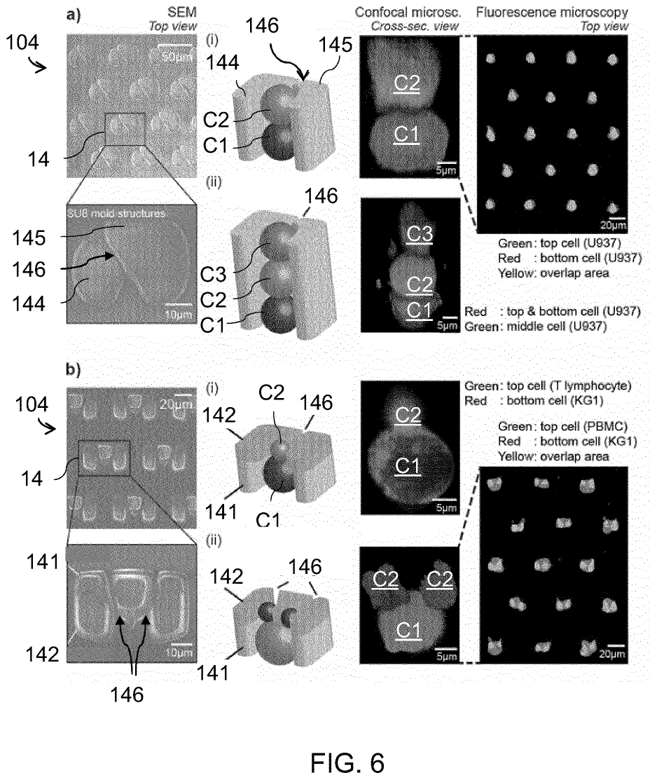

FIG. 6 illustrates different but non-limitative trap topologies that allowed the vertical assembly of (a) similar size cells and (b) cells of different sizes as doublets (i) or triplets (ii). Single or multi-layer traps 14 (SEM images, top view) formed cell assemblies as shown schematically and were monitored with confocal microscopy (cross-sectional view). Cell assemblies were formed in parallel within the microfluidic channel (top view).

### Individual Access to a Cell

Once a cell assembly has been built in the traps, it is possible to selectively treat one or several selected cells of the assembly with an agent.

To that end, an agent can be injected in the microfluidic channel through the main inlet, the first auxiliary inlet and/or the second auxiliary inlet, depending on the position of the target cell(s) in the assembly.

The analysis of the real-time interactions of the trapped pair or triplet of cells may involve exposing at least one cell of the cell assembly to a solution having a specific property, such as pH or viscosity, to simulate cell interactions in specific conditions. One or more solutions with different properties may thus be flown in the microfluidic channel in order to selectively access to a specific cell or to collectively access to the whole trapped cell assembly.

In some embodiments, a selected cell or the whole trapped cell assembly can be exposed to a solution with variable pH, in particular an acidic pH (for example about 6.2 to 6.5), which is less than the pH found in normal tissues (about 7.4). This allows accounting for the variability existing in vivo or in non-healthy conditions (acidic microenvironment in cancer tissue or in bone marrow).

In other embodiments, a selected cell or the whole trapped cell assembly can be exposed to solutions having various viscosities, for example to mimic cell interaction in blood (the solution thus having a viscosity from 3 to 5 cP (3-5 mPa·s) which corresponds to average blood viscosity) and/or in bone marrow (the solution thus having a viscosity from 30 to 38 mPa·s which corresponds to average bone marrow viscosity).

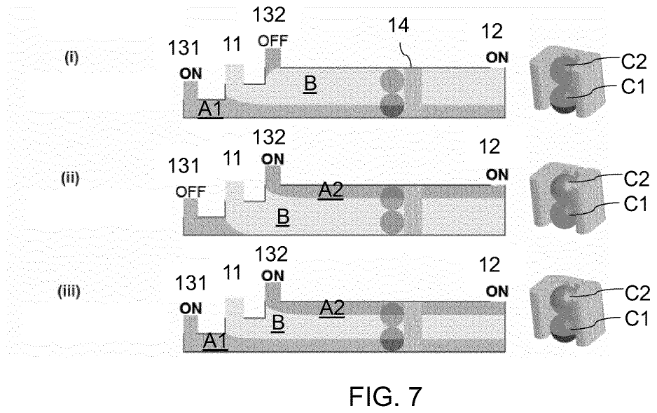

FIG. 7 illustrates two alternative ways of selectively accessing to two cells C1, C2 of a cell pair.

In step (i), in order to access the bottom cell C1, a first agent A1 is injected through the first auxiliary inlet 131 and a buffer B is injected through the main inlet 11. The second auxiliary inlet 132 is closed. The flow rate at the first auxiliary inlet 131 relative to the flow rate at the outlet 12 is controlled to adjust the thickness of the flow of the first agent A1 to be smaller than the thickness of the bottom cell C1. In this way, only the bottom cell C1 is treated by the first agent A1.

In step (ii), which is optional, it is possible to also selectively treat the top cell C2 with a second agent A2, which can be different from the first agent or identical to the first agent. To that end, the first auxiliary inlet 131 is closed, a buffer B is injected through the main inlet and the second agent A2 is injected through the second auxiliary inlet 132. The flow rate at the second auxiliary inlet 132 relative to the flow rate at the outlet 12 is controlled to adjust the thickness of the flow of the second agent A2 to be smaller than the thickness of the top cell C2. In this way, only the top cell C2 is treated by the second agent A2.

As an alternative to steps (i) and (ii) that are carried out successively, it is possible to treat concurrently the bottom cell C1 and the top cell C2 with the first and second agents A1, A2, respectively (iii). To that end, the first and second agents A1, A2 are injected at the same time through the first and second auxiliary inlets 131, 132, respectively, and a buffer B is injected through the main inlet 11 to separate the first and second agents. The flow rate at the first and second auxiliary inlets 131, 132 relative to the flow rate at the outlet 12 is controlled to adjust the thickness of the flow of the first and second agents A1, A2 to be smaller than the thickness of the bottom and top cells C1, C2, respectively. In this way, each cell is only treated by the respective agent and not by the other one.

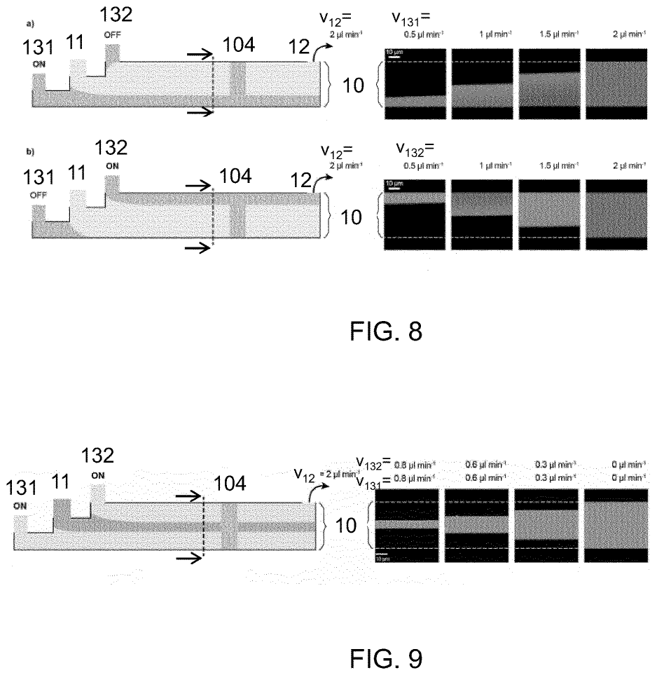

FIG. 8 illustrates a side view (left) and a cross-sectional view acquired by confocal microscopy of the flow of labeled microspheres injected through the main channel in the microfluidic channel (right) with flow conditions for the separate access to individual cell types. The height of the “virtual” channel at (a) the bottom or (b) the top of the actual microfluidic channel was altered by changing the flows at the first and second auxiliary inlets. As the outlet flow was kept withdrawing at a constant rate (2 μl min⁻¹), the flow condition at the trapping area was the same throughout the experiments. In a), higher flow rates at the first auxiliary inlet increase the height of the “virtual” channel at the bottom (the flow rate at the second auxiliary inlet being 0 μl min⁻¹), and b) higher flow rates at the PI2 increase the height of the “virtual” channel at the top (the flow rate at the first auxiliary inlet being 0 μl min⁻¹). The sequential use of the auxiliary inlets allows accessing each cell type consecutively.

FIG. 9 illustrates a side view (left) and a cross-sectional view acquired by confocal microscopy of the flow of labeled microspheres injected through the main channel in the microfluidic channel (right) with flow conditions for the separate access to individual cell types. As compared to the experiment of FIG. 8, the first and auxiliary inlets 131, 132 were used concurrently.

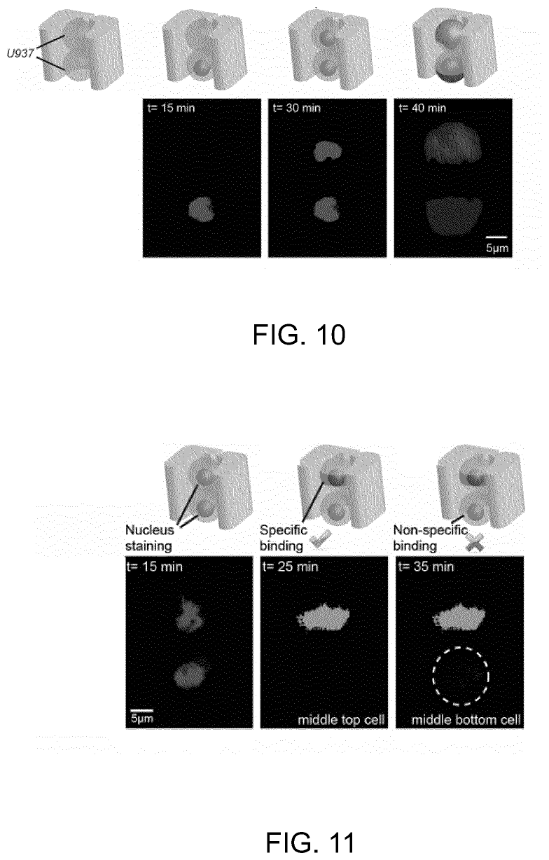

FIG. 10 illustrates individual access to U937 cell types performed either consecutively, e.g., Hoechst delivery to the bottom cell (left), followed by the top cell (middle) for staining the nucleus of said cells, or concurrently, e.g., simultaneous delivery of DiO to the top cell and Dil to the bottom cell (right) for staining the membrane of both cells.

As shown in FIG. 11, the nucleus of both U937 cells was staining by Hoechst (left). Specific binding was demonstrated using CD45-FITC antibodies, selectively delivered to the top cell membrane (middle). As a control, FITC-labeled non-specific isotype antibodies delivered to the bottom cell (dotted circle) showed no notable binding (right).

In some embodiments, after trapping and treating the cell assemblies, it may be possible to release a selected cell assembly thanks to the generation of a bubble in the solution surrounding the traps, by electrolysis of said solution. To that end, the microfluidic device includes, in the bottom of the microfluidic channel, a plurality of electrically isolated electrodes arranged to form an array. The nodes of the array (i.e. the areas in which two electrodes overlap) are located under the traps. In this way, when a sufficient potential difference is applied between two overlapping electrodes (i.e. a potential difference greater than a potential difference triggering electrolysis of the solution), a bubble is generated on the bottom of the microfluidic channel and rises in the solution in a substantially vertical direction so as to push the cell assembly out of the trap. The released cell assembly may then be driven along the microfluidic channel by the flow of solution.

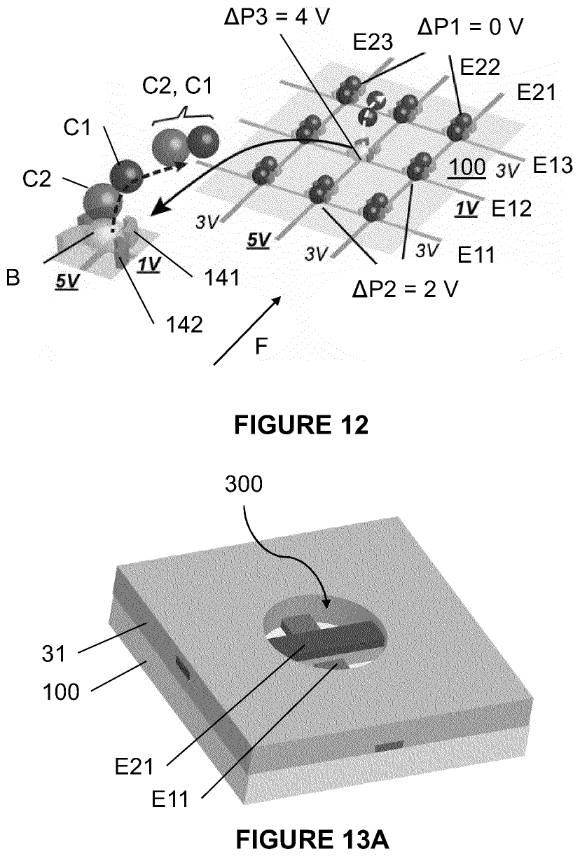

FIG. 12 schematically illustrates an array of electrodes arranged on the bottom 100 of the microfluidic channel. A first set of electrodes E11, E12, E13 extend perpendicular to the direction of flow F, whereas a second set of electrodes E21, E22, E23 extend parallel to the direction of flow F, and thus perpendicular to the first set of electrodes E11, E12, E13. Each electrode of the first set crosses an electrode of the second set under a respective trap. By “under” is meant here that the crossing or overlapping area is aligned with the trap zone along a line perpendicular to the bottom of the microfluidic channel.

The first and second sets of electrodes are electrically isolated from each other.

Each electrode is connected to an electrical source configured to selectively apply a determined electrical potential to each electrode. As a result, a potential difference may be generated at each crossing area.

Depending on the electrical potential applied to each electrode, said potential difference may be greater than a potential threshold allowing electrolysis of the solution flowing in the microfluidic channel. In such case, a bubble is generated in the crossing area and rises in the solution to push a cell assembly from the respective trap. Thus, the cell assembly can be retrieved from the trap without requiring to reverse the flow of solution within the microfluidic channel and without requiring releasing cell assemblies from the other traps.

On the contrary, if the potential difference is less than the potential threshold, no electrolysis occurs and the cell assembly remains in the trap.

For example, in the embodiment illustrated in FIG. 12, an electrical potential of 3 V is applied to electrodes E11, E13, E21 and E23, an electrical potential of 1 V is applied to electrode E12 and an electrical potential of 5 V is applied to electrode E22. As a result, a potential difference ΔP1=0 V is applied at the crossing area between electrodes E13 and E21 and between electrodes E13 and E23; a potential difference ΔP2=2 V is applied at the crossing area between electrodes E12 and E21 and between electrodes E11 and E22; a potential difference ΔP3=4 V is applied at the crossing area between electrodes E12 and E22. Of course, the number of electrodes of each set and their relative arrangement is presented only for illustration and is not intended to be limitative.

Assuming that a potential difference of at least 3V is necessary to generate electrolysis of the solution, potential differences ΔP1 and ΔP2 are too low to generate electrolysis at the corresponding crossing areas; however, electrolysis is generated at the crossing area between electrodes E12 and E22 since ΔP3 is greater than 3 V. As a result, a bubble B is formed at the crossing area and rises in a substantially vertical direction to push the cell pair C1, C2 from the trap.

The applied potential difference depends on the electrode material, electrode geometry, and the solution (buffers or culture media) ionic strength and may be up to 20V DC. AC signals (up to 1 or 2 MHz) can also be applied for dielectrophoresis or AC electroosmosis to release a cell, cell pair or cell triplet.

The electrode array may be fabricated by patterning an electrically conductive material (such as indium tin oxide (ITO), or a metal such as gold) to form a first set of electrodes (e.g. a set of parallel electrodes) on the bottom of the microfluidic channel. The thickness of the electrodes can reach up to 500 nm. These electrodes are covered with a first dielectric layer, the thickness of the dielectric layer being greater than the thickness of the electrodes, so as to electrically isolate each electrode. The dielectric material may be for example SiO2, spin-on-glass, or CYTOP™, which is a fluoropolymer.

A second set of electrodes is patterned perpendicular to the first set of electrodes and is then covered by a second dielectric layer having a thickness greater than the thickness of the electrodes so as to electrically isolate each electrode. The width of each electrode is of the same order as the size of the cells to be captured, for example a few micrometers.

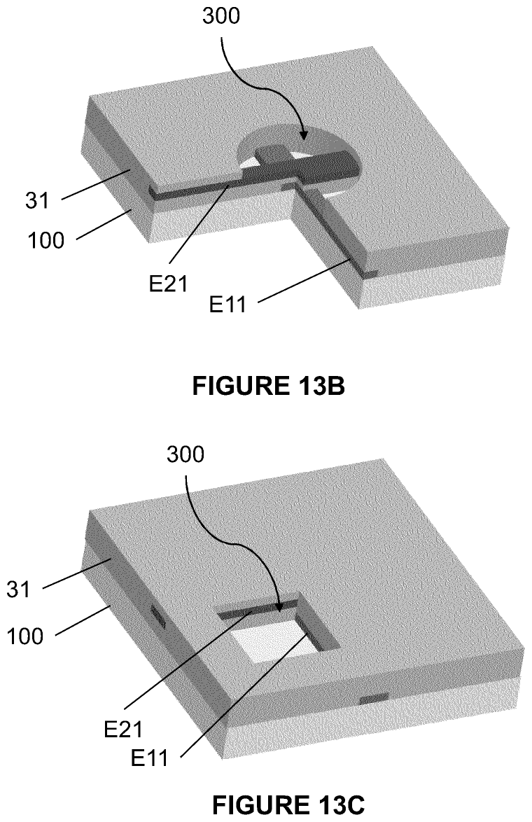

Then, the dielectric layers are etched around the overlapping electrode areas in order to form a recess in which at least a part of each electrode is exposed to the solution flowing in the microfluidic device. FIGS. 13A-13C schematically illustrate various embodiments of such a recess.

FIG. 13A illustrates a part of the bottom of the microfluidic device according to an embodiment, comprising a part of a first electrode E11 and of a second electrode E21 partially overlapping the first electrode. As mentioned above, the electrodes E11 and E21 are embedded in the first and second dielectric layers (here represented as a single dielectric layer 31). The recess 300 is formed through the dielectric layer 31 until the bottom 100 of the microfluidic channel. As best seen in FIG. 13B which is a partial sectional view of the recess of FIG. 13A, the etching partially exposes the upper and side surfaces of the second electrode E21 and the upper and side surfaces of the first electrode E11 on both sides of the overlapping second electrode E21. However, the etching does not remove the dielectric material located between the first and second electrodes.

The recess may have a circular shape, as represented in FIGS. 13A-13B, but it may have any suitable shape, for example rectangular or square (as shown in FIG. 13C). In the illustrated embodiment, the recess is centered on the overlapping area, but it could be placed differently, provided that at least part of the upper and/or side surfaces of each electrode is exposed.

FIG. 13C illustrates a part of the bottom of the microfluidic device according to another embodiment, comprising a part of a first electrode E11 and of a second electrode E21 partially overlapping the first electrode. As in FIG. 13A, the electrodes E11 and E21 are embedded in the first and second dielectric layers (here represented as a single dielectric layer 31). The recess 300 is formed through the dielectric layer 31 until the bottom 100 of the microfluidic channel. Contrary to the embodiment of FIG. 13A, the etching only exposes a side surface of the first and second electrodes E11, E21. In this embodiment, the recess is thus formed along one side surface of electrodes E11 and E21. As mentioned above, the etching does not remove the dielectric material located between the first and second electrodes.

The recesses allow the solution to be in contact with the electrodes only in the overlapping areas, or in the vicinity of the overlapping areas. Each recess is formed right below the traps allowing forming cell assemblies.

The size of the recess (e.g. the diameter for a circular recess, or the length/width for a square or rectangular recess) is chosen so as to generate a bubble of a size suitable for pushing the cell or cell assembly. To that end, the size of the recess (and of the resulting bubble) is equal to or slightly greater than the size of the cells, which may be of the order of 10 μm.

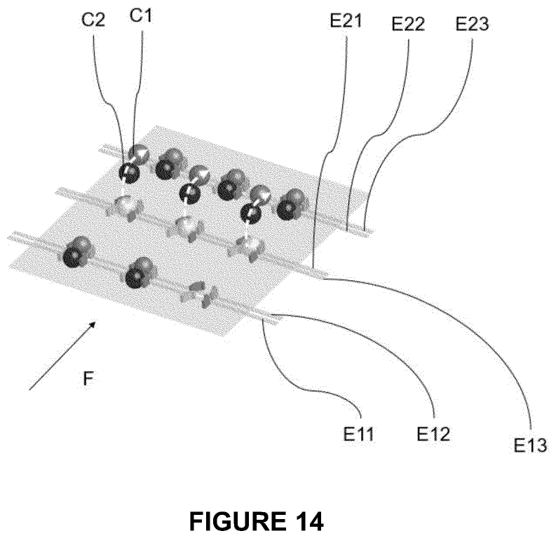

In an embodiment illustrated in FIG. 14, the electrodes are gathered by pairs and the electrodes of each pair are arranged parallel to each other. Advantageously, as illustrated in FIG. 14, each electrode has the shape of a line which is parallel to the electrode of the same pair. Advantageously, the electrodes of a pair are arranged parallel to the electrodes of other pairs. An area of the pair of electrodes is located under each trap. In other words, at least a part of each electrode of a pair of electrodes is located under each trap. Several traps may be arranged along each pair of electrodes. Advantageously, at least one surface of each electrode of the pair of electrodes is exposed in a recess formed around said area of the pair of electrodes. Each electrode is connected to an electrical source so as to selectively apply a potential difference to the solution at each area of the pair of electrodes.

### EXAMPLES AND EXPERIMENTS

The inventors validated the efficiency of the microfluidic device in terms of pairing and selective treatment of a cell of a cell assembly by various experiments.

### Manufacturing Process

The device consists of a patterned PDMS piece bonded on a glass coverslip. The PDMS piece was prepared in two steps: fabrication of the mold by SU8 photolithography and PDMS molding on the fabricated structures. The device was designed to have three parts: (i) an inlet area (three inlets and a filter area), (ii) a trapping area, and (iii) an outlet. Inlets consist of a central inlet to inject cells and two peripheral inlets (first auxiliary inlet, second auxiliary inlet) for reagent supply. The filter area has vertical pillars of 50 μm diameter, forming an array with a 50-μm gap between the rows and columns for single cells to pass safely while preventing large aggregates or debris from reaching mechanical traps. The trapping area is the part where cells are assembled. The trap geometry changes according to target cell dimensions and assembly condition (single or multiple cells). As the last part, the outlet is connected to a pressure pump providing a constant flow in the trapping area for monitoring cellular activity under stable conditions.

The mold was fabricated by patterning four layers of SU8 on a silicon wafer to have channels 50 μm high for triplet demonstrations, 38 μm high for doublet demonstrations, and 30 μm high for demonstrating assemblies of different cell sizes. The first layer corresponds to a continuous flow layer except for the filter pillars and the trap array's supporting pillars. The second and fourth layers of SU8, corresponding to first and second auxiliary inlets, have fixed thicknesses, i.e., 10 μm and 5 μm, respectively. The third layer, used for the main inlet, has a thickness depending on the total channel height. The first layer, having 2 μm of thickness, was created by spin-coating SU8 2002 (3500 rpm, 30 s) on a 3-inch silicon wafer. Following a soft-bake (2 minutes at 95° C.), the wafer was exposed (a dose of 100 mJ cm-2 using a 375 nm laser, Heidelberg MLA-150, maskless lithography system) and post-baked (2 minutes at 95° C.). The second layer, forming the first auxiliary inlet, was fabricated with SU8 3010. The resist was spin-coated (4000 rpm, 30 s) to have an 8 μm thickness. Then, the wafer was soft-baked (1 minute at 65° C. and 10 minutes at 95° C.), exposed (150 mJ cm-2), and post-baked (2 minutes at 65° C. and 5 minutes at 95° C.). The third layer, forming the main inlet and the first layer of multi-layer trap arrays, was fabricated with SU8 3025. The resist was spin-coated at 2000 rpm and 4300 rpm for 30 s to achieve 35 μm and 23 μm of thickness, respectively, for the single-layer trap array (for cell triplets and doublets, respectively). For a multi-layer trap array, we coated SU8 3005 at 800 rpm for a thickness of 15 μm. The wafer was soft-baked (1 minute at 65° C. and 15 minutes at 95° C.), exposed (220 mJ cm-2), and post-baked (2 minutes at 65° C. and 5 minutes at 95° C.). The fourth layer, forming P12, filter area, and capture traps (2nd layer for the multi-layer trapping arrays), had SU8 2005 spin-coated (1000-2500 rpm for 30 s) to have 5-8 μm of thickness. The coated wafer was soft-baked (1 minute at 65° C. and 5 minutes at 95° C.), exposed (220 mJ cm-2), and post-baked (1 minute at 65° C. and 5 minutes at 95° C.). After completing all layers, the photoresist was developed in an SU8 developer solution and hard-baked (15 minutes at 150° C.). Finally, a thin layer of Teflon was deposited (Oxford PlasmaPro80, 100 W, C4F8, 30 mTorr, 30 s) for easy releasing of the PDMS piece after molding.

PDMS mixture (10:1 for the base elastomer and curing agent) was degassed and poured onto the silicon wafer with SU8 structures. The thickness of the PDMS was ~1.5 mm to restrict the central inlet reservoir volume at a reasonable value for rapid injection of cell suspensions. After five hours of curing at 70° C., solidified PDMS was peeled off and cut into pieces. The first and second auxiliary inlets and outlet openings were created using 0.5 mm diameter biopsy punchers (for connecting them to a pressure pump), and the main inlet opening was made using 1.5 mm diameter biopsy punchers. The PDMS was then bonded to a glass coverslip (0.17 mm thickness) by activating the bottom surface of the PDMS with a plasma cleaner (Harrick, Hi-level, 5 minutes) and baking for 30 minutes at 90° C. The top surface of the PDMS was covered with tape to protect the inherent hydrophobic surface properties, which could be tempered during the plasma cleaning.

### Setup and Protocol

The inventors used (i) a confocal microscope (ZEISS LSM 880) for the experiments requiring 3D visualization and (ii) an inverted microscope (Olympus IX83) for characterizing pairing efficiency.

The microfluidic device, placed on a microscope stage, was connected to a pressure pump (Fluigent, LineUp™ Push-Pull) via three controllers. Two controllers were connected to first and second auxiliary inlets and the third one to the outlet. Each controller had a dedicated flow sensor (Fluigent, FLU-M-D) for precise control of the liquid flow rate (in/out). The auxiliary inlets controllers always worked on the infusion mode to inject solutions into the channel, and the outlet controller always worked on the withdrawal mode to remove solutions from the device.

Before experiments, the microfluidic device was treated with a pluronic (F-127) solution (50 mg mL⁻¹) to avoid non-specific attachments on the channel surface. A syringe pump (Kd Scientific) was connected at the outlet with an injection flow rate of 25 μl min⁻¹ for 3 minutes and 5 μl min⁻¹ for 7 minutes. The device was then rinsed by injecting deionized water from both PIs (25 μl min⁻¹) and withdrawing from the outlet (20 μl min⁻¹) for 10 minutes. The outlet flow rate was lower than auxiliary inlets flow rates to create a backflow from the auxiliary inlets to the main inlet to rinse the main inlet reservoir. The channel was filled with culture medium via first and second auxiliary inlets using the same rinsing configuration for 5 minutes. A surrogate PDMS layer (<1 mm in thickness) with an opening of 1.2 mm diameter was placed over the main inlet to maintain the inherent hydrophobic surface property of the device. This PDMS piece helped to protect the sample from spilling at the main inlet during the experiment. After surface treatment, the device was placed on the microscope stage, and microfluidic connections were made.

Stacked flows were characterized using fluorescent polymer microspheres, 0.50 μm (FSDG003, Bangs Laboratories, Inc.). Different flow conditions were used to control the dimension of each flow (FIG. 4 (top)). Similarly, a thin virtual channel could be positioned along the height of the channel only by controlling the auxiliary inlets flows and keeping the outlet flow at 2 μl min⁻¹(FIG. 4 (bottom), FIG. 8, FIG. 9). Monitoring the stacked flow conditions between passive structures inside the channel, i.e., before the filter, between the filter and traps, and after traps, showed that these structures exhibit a negligible effect on stacked flows.

The first step of the experimental protocol was assembling cells at the traps. The outlet withdrew liquid from the channel at a constant flow rate (2 μl min⁻¹) throughout experiments for all trap topologies. The inventors injected cells (150 000 cells ml⁻¹, Table 1) at the main inlet while adjusting auxiliary inlets flow conditions according to the target assembly geometry (Table 2). Flow conditions were kept for 5 minutes for each cell layer, with an additional rinsing session of 5 minutes in between.

TABLE 1
Different cell types demonstrating assemblies
with different trap geometries.

| Cell type | Cell-assembly demonstration |
|---|---|
| U937 | All cells: Same size doublets (FIGS. 6a)i), 10, 11) |
| | and same size triplets (FIG. 6a)ii)) |
| KG1 | Bottom cell: Different size doublets (FIG. 6b)i)) |
| | and different size triplets (FIG. 6b)ii)) |
| CD8⁺ T | Top cell: Different size doublets (FIG. 6b)i)) |
| lymphocytes | |
| Peripheral blood | Top cells: Different size triplets (FIG. 6b)ii)) |
| mononuclear cells | |
| (PBMC) | |

TABLE 2
Flow conditions for peripheral inlets and the outlet
for assembling cells as doublets and triplets.

| | Flow conditions for | | Flow conditions for | | |
|---|---|---|---|---|---|
| | doublets (μl min⁻¹) | | triplets (μl min⁻¹) | | |
| | Cell #1 | Cell #2 | Cell #1 | Cell #2 | Cell #3 |
| First auxiliary | 0 | 0.7 | 0 | 0.5 | 1 |
| inlet (infuse) | | | | | |
| Second auxiliary | 0.7 | 0 | 1 | 0.5 | 0 |
| inlet (infuse) | | | | | |
| Outlet | 2 | 2 | 2 | 2 | 2 |
| (withdraw) | | | | | |

The second step was individual access to cells in an assembly. The auxiliary inlets and outlet flows provide independent access to cells separately or concurrently. The flow stability at the trapping area was maintained by keeping the outlet flow condition unchanged (2 μl min⁻¹). Different peripheral inlet flow conditions were adapted to deliver molecules/drugs to different parts of vertically assembled cells.

The individual access could be performed consecutively with only one peripheral inlet for each cell type. The first auxiliary inlet delivered Hoechst (1 μg ml¹) to the bottom cell for 10 min (first auxiliary inlet at 0.5 μl min⁻¹, second auxiliary inlet at 0 μl min⁻¹). Then, the first auxiliary inlet was set to 0 μl min⁻¹, and the channel was rinsed with culture medium for 5 minutes and injected at the main inlet. The inventors delivered Hoechst to the top cell via the second auxiliary inlet (0.5 μl min⁻¹) while the first auxiliary inlet was kept at 0 μl min⁻¹. After 10 minutes of flow, the channel was rinsed again. A concurrent access, on the other hand, required collective use of both auxiliary inlets. Following the nucleus staining, the inventors injected Dil (1 μM) at the first auxiliary inlet and DiO (1 μM) at the second auxiliary inlet simultaneously with a flow rate of 0.5 μl min⁻¹ for 5 minutes to stain cell membranes. The Dil stained the bottom part of the bottom cell while the DiO stained the top part of the top cell. The inventors used microfluidic switches (2-Switch Fluigent) at the auxiliary inlets for injecting the required solution (culture medium for assembly or drugs/stains for accessing cells) in the channel.

Specific access to a chosen cell did not have to be only for the top of the top cell or the bottom of the bottom cell. Using both auxiliary inlets and injecting the molecules/drugs at the main allowed access to the middle regions of cells. The inventors used specific binding with immunocytofluorescence staining to test both access types. They demonstrated the former protocol with FITC-labeled anti-CD45 antibody solution (1 μg mL⁻¹) injected at the first auxiliary inlet (0.2 μl min⁻¹ for 5 minutes), targeting the bottom cell. After washing with culture medium for 5 min via the main inlet, the top cell was exposed to an isotype-FITC (1 μg mL⁻¹) via the second auxiliary inlet (0.5 μl min⁻¹ for 5 min) as control. The results showed that only the specific binding condition resulted in successful staining, which was confirmed by changing the order of the staining, i.e., CD45-FITC to the top cell and isotype-FITC to the bottom cell (FIG. 11). The latter protocol, i.e., accessing the middle parts of a cell, was demonstrated by delivering CD45-FITC via the main inlet, while the first auxiliary inlet and second auxiliary inlet flowing culture medium at 1.2 μl min⁻¹ and 0.3 μl min⁻¹, respectively (FIG. 7. The control with isotype-FITC was conducted with the corresponding conditions.

A multi-layer cell doublet geometry was demonstrated for cellular activity analysis using consecutive access to assembled cells. Before experiments, cells were incubated for 30 min at 37° C. with Fluo4 (2 μM) diluted in RPMI medium. After centrifugation, cells were washed and suspended in an extracellular solution (140 mM NaCl, 5 mM KCl, 1 mM MgCl2, 2 mM CaCl2, 10 mM glucose, 10 mM Hepes) to react to the calcium ionophore ionomycin. Cells were assembled by injecting cell types consecutively, as explained above. At first, the KG1 cell line (150 000 cells ml⁻¹) was injected via the main inlet (first auxiliary inlet at 0 μl min⁻¹, second auxiliary inlet at 0.5 μl min⁻¹, and outlet -withdrawing- at 2 μl min⁻¹) for 5 minutes. Then, primary human CD8⁺ T lymphocytes (150 000 cells ml⁻¹) were injected via the main inlet (first auxiliary inlet at 1.5 μl min⁻¹, second auxiliary inlet at 0 μl min⁻¹, and outlet-withdrawing- at 2 μl min⁻¹) for 5 minutes. The activity was monitored with confocal images taken every 3 minutes. lonomycin (10 μg mL⁻¹) was delivered to the bottom cell via the first auxiliary inlet (0.5 μl min⁻¹) for 7 minutes, while the second auxiliary inlet was set to 0 μl min⁻¹. The ionomycin was washed for 5 minutes (at t=12 min) before repeating the process for the top cell by changing the second auxiliary inlet flow to 0.2 μl min⁻¹ and first auxiliary inlet flow to 0 μl min⁻¹ at t=20 min for 7 minutes. The ionomycin was then washed again for 5 minutes (at t=27 min).

### Finite Element Modelling

Before fabrication, the device was modelled and optimized using the finite element method (FEM). COMSOL Multiphysics (v.5.5) platform was used for drawing the microchannel geometry. The geometry, identical to the actual device, was then used for the simulation. The developed model uses two physics: laminar flow and transport of diluted species. Both physics were built into the microfluidics module and solved in the fluid domain. The flow motion was obtained by solving the Navier-Stokes equations for an incompressible Newtonian fluid. The incompressible Newtonian flow in the fluid domain has a low Reynold's number (Re<1) and is described by a coupled system of the Navier-Stokes equation,

$$ρ [ \frac{\partial v}{\partial t} + ( v \cdot ∇ ) v ] = - ∇ p + μ {∇}^{2} v$$

$$∇ \cdot v = 0$$

where v is the velocity (m s⁻¹), p is the pressure (Pa), ρ is the density (kg m⁻³), p is the viscosity (kg m⁻¹ s⁻¹), and t is the time (s). All velocity conditions followed the experimental protocols. The equations were solved for a steady-state flow with no-slip boundary conditions using a generalized minimal residual method (GMRES) solver for mesh with a typical number of elements of 40 000.

Stacked flows were simulated by solving the transport of dilute species physics. The species concentration was monitored using the conviction diffusion equation,

$$\frac{\partial c}{\partial t} = D {∇}^{2} c - v \cdot ∇ c$$

where c is the concentration (mol m⁻³) and D is the diffusion coefficient (m² S⁻¹). The main and first and second auxiliary fluid concentrations were set to 0 and 1. In the first approach, the first and second auxiliary inlets and outlet flows were set to 0 μl min⁻¹. The parametric sweep study conditions were then applied to the first and second auxiliary inlets and outlet to alter the flow conditions (Table 3). The diffusion concentration was 10⁻⁹ m² s⁻¹ and water was chosen as fluid for all the conditions.

TABLE 3
Flow conditions for simulating stacked flows.

| First | Second | | Flow ratio 1 | Flow ratio 1 |
|---|---|---|---|---|
| auxiliary | auxiliary | | (r₁) | (r₂) |
| inlet flow | inlet flow | Outlet flow | (second auxiliary | (first auxiliary |
| (μl min⁻¹) | (μl min⁻¹) | (μl min⁻¹) | inlet:outlet) | inlet:outlet) |
| 0 | 0.5 | 2 | 0 | 0.25 |
| 0 | 1 | 2 | 0 | 0.5 |
| 0 | 1.5 | 2 | 0 | 0.75 |
| 0 | 2 | 2 | 0 | 1 |
| 0.5 | 0 | 2 | 0.25 | 0 |
| 1 | 0 | 2 | 0.5 | 0 |
| 1.5 | 0 | 2 | 0.75 | 0 |
| 2 | 0 | 2 | 1 | 0 |
| 0.5 | 0.5 | 2 | 0.25 | 0.25 |

### Cell Preparations

Different cell types were used for the experiments, e.g., human leukemia cell lines (KG1, U937), PBMC, and CD8⁺ T lymphocytes.

KG1 cell line (CCL-246™-ATCC®) was cultured in RPMI 1640 medium (Gibco, Waltham, MA, USA), supplemented with 1% penicillin-streptomycin antibiotic cocktail (Gibco) and 20% of fetal bovine serum (FBS) (Gibco).

All cells were kept in an incubator at 37° C. in a humidified atmosphere (−95%) with a supply of 5% CO₂.

The U937 cells (CCL-246™ and CRL-1593.2™; ATCC®) were cultured following the same process used for the KG1 cell lines except for reducing the FBS to 10%.

Purification and separation of PBMC from blood of healthy donors were facilitated by Ficoll-Hypaque density gradient centrifugation. Human primary CD8⁺ T lymphocytes were negatively selected from PBMC using the EasySep™ Human CD8⁺ T Cell Isolation Kit and column-free magnetic cell separation technique (Stem Cell Technology).

CD8⁺ T lymphocytes were cultured for three days to activate them using Dynabeads™ Human T-Activator CD3/CD28 (Gibco) with the ratio 1:1 and 0.1 μg ml⁻¹ of IL-2 (Ozyme).

After three days, anti-CD3/CD28 coated Dynabeads were removed using a magnetic separation column (Stem Cell Technology).

The activated CD8⁺ T lymphocytes were resuspended into RPMI 1640 medium (Gibco, Waltham, MA, USA), supplemented with a 1% penicillin-streptomycin antibiotic cocktail (Gibco) and 10% of FBS (Gibco).

In addition, the inventors added 0.1 μg ml⁻¹ of IL-2 and then incubated for seven days.

The cell solutions were treated with DNase (50 U ml⁻¹) to prevent long DNA segments from sticking in the microfluidic device.

The remaining aggregates were removed using a 30 μm pore size filter (MACS® SmartStrainers), helping the solution to have single cell suspensions before injection into the device.

### In Situ Staining and Stimulation of Single Cells

Dil and DiO (Life Technologies) were prepared following the manufacturer's instructions for cell membrane staining.

Hoechst (33342, NucBlue® Live ReadyProbes®) solution (1 μg mL⁻¹) was prepared for staining the cell nucleus.

The antibody staining was performed by perfusion of anti-CD45 antibody conjugated with FITC (Invitrogen).

For control experiments, the corresponding isotype conjugated with FITC was used (Invitrogen).

Intracellular calcium level was measured using the fluorescent calcium dye Fluo-4 AM (Invitrogen).

In situ stimulation of single cells was performed by loading the cells in serum-free RPMI 1640 (phenol red-free; Gibco) at 37° C. and 5% CO₂ for 45 min.

Cells were then washed before use.

### CITATIONS

[1]F. A. Shaik et al., “Pairing cells of different sizes in a microfluidic device for immunological synapse monitoring,” Lab Chip, vol. 22, no. 5, pp. 908-920, Mar. 1, 2022, doi: 10.1039/d1lc01156a.

1. A microfluidic device for forming a cell assembly comprising at least one first cell and one second cell and for individually treating a selected cell of the cell assembly, comprising:
a microfluidic channel;
a main inlet for a fluid, the fluid being a first solution containing first cells or a second solution containing second cells, arranged in a first portion of the microfluidic channel;
an outlet arranged in a second portion of the microfluidic channel for controlling a flow rate of the fluid in the microfluidic channel;
at least one first auxiliary inlet for a first auxiliary fluid arranged in the first portion of the microfluidic channel upstream or downstream of the main inlet;
at least one cell trap arranged in the microfluidic channel between the first portion and the second portion,
wherein each cell trap comprises a first trapping portion and a second trapping portion, the first trapping portion and the second trapping portion being sized to receive a respective first or second cell, the first trapping portion and the second trapping portions being adjacent to each other in a direction perpendicular to a bottom of the microfluidic channel to form the cell assembly with the at least one first cell trapped in the first trapping portion and the at least one second cell trapped in the second trapping portions, the at least one trapped first cell and the at least one trapped second cell being at a different height relative to the bottom of the microfluidic channel,
at least one first valve for controlling a flow rate of the first auxiliary fluid so as
to cause the first solution containing the first cells to flow at a first determined height, in the microfluidic channel in order to bring the first cells to the first trapping portion, and
to cause the second solution containing the second cells to flow at a second determined height in the microfluidic channel in order to bring the second cells to the second trapping portion.

2. The microfluidic device of claim 1, further comprising at least one second auxiliary inlet for a second auxiliary fluid arranged in the first portion of the microfluidic channel and at least one second valve for controlling a flow rate of the second auxiliary fluid, the second auxiliary inlet being arranged relative to the main inlet and the first auxiliary inlet so as to cause the fluid to be pinched between the first auxiliary fluid and the second auxiliary fluid.

3. The microfluidic device of claim 1, wherein the main inlet, the first auxiliary inlet and, if appropriate, the second auxiliary inlet are arranged at different heights relative to the bottom of the microfluidic channel, said heights increasing along a flow direction.

4. The microfluidic device of claim 1, wherein the main inlet, the first auxiliary inlet and, if appropriate, the second auxiliary inlet, presents a width substantially equal to a width of the microfluidic channel.

5. The microfluidic device of claim 1, further comprising a filter arranged in the microfluidic channel between the first portion of the microfluidic channel and the at least one cell trap.

6. The microfluidic device of claim 1, comprising a plurality of cell traps in a staggered arrangement in the microfluidic channel.

7. The microfluidic device of claim 1, wherein the first trapping portion and the second trapping portions have different sizes, in particular different heights.

8. The microfluidic device of claim 1, wherein at least one trapping portion among the first trapping portion and the second trapping portion is configured to trap at least two cells of a same size.

9. The microfluidic device of claim 1, wherein at least one of the main inlet, the first auxiliary inlet and, if appropriate, the second auxiliary inlet is adapted to introduce a respective agent in the microfluidic channel, the at least one first valve, and, if appropriate, the at least one second valve being configured to control a flow rate of the agent so as to cause said agent to flow at a determined height in the microfluidic channel in order to bring said agent selectively to the at least one trapped first cell and/or to the at least one trapped second cell.

10. The microfluidic device of claim 1, further comprising an array of electrodes electrically isolated from each other and arranged on a bottom of the microfluidic channel such that an overlapping area of two electrodes is located under each cell trap, at least one surface of each electrode being exposed in a recess formed around the overlapping area, each electrode being connected to an electrical source so as to selectively apply a potential difference to a solution at the overlapping area.

11. The microfluidic device of claim 1, further comprising at least one pair of electrodes, wherein electrodes of each pair of electrodes are electrically isolated from each other and arranged parallel to each other on the bottom of the microfluidic channel such that an area of each pair of electrodes is located under each cell trap, at least one surface of each electrode of the pair of electrodes being exposed in a recess formed around the area of each pair of electrodes, each electrode being connected to an electrical source so as to selectively apply a potential difference to a solution at each area of the pair of electrodes.

12. A method for forming a cell assembly comprising at least one first cell and one second cell with a microfluidic device comprising:
a microfluidic channel;
at least one main inlet for a fluid, the fluid being a first solution containing first cells or a second solution containing second cells, arranged in a first portion of the microfluidic channel;
an outlet arranged in a second portion of the microfluidic channel for controlling a flow rate of the fluid in the microfluidic channel;
at least one first auxiliary inlet for a first auxiliary fluid arranged in the first portion of the microfluidic channel upstream or downstream of the at least one main inlet;
at least one cell trap arranged in the microfluidic channel between the first portion and the second portion,
wherein each cell trap comprises at least one first trapping portion and one second trapping portion, the first trapping portion being sized to retain a first cell and the second trapping portion being sized to retain a second cell, the first cell being at a first height relative to a bottom of the microfluidic channel, and the second cell being at a second height relative to the bottom of the microfluidic channel different from the first height,
the first trapping portion and the second trapping portion being adjacent to each other in a direction perpendicular to the bottom of the microfluidic channel to form the cell assembly with the first cell retained in the first trapping portion and the second cell retained in the second trapping portion,
at least one first valve for controlling a flow rate of the first auxiliary fluid,
said method comprising:
flowing the first solution comprising the first cell in the microfluidic channel,
causing said first solution to flow at a first height in the microfluidic channel using a flow of at least one auxiliary fluid, so as to bring the first cell to the first trapping portion,
flowing the second solution comprising the second cell in the microfluidic channel,
modifying the flow rate of the auxiliary fluid to control the second solution to flow at a second height so as to bring the second cell to the second trapping portion.

13. The method of claim 12 for forming a cell assembly comprising at least three cells at in first, second and third trapping portions located at different first, second and third heights relative to the bottom of the microfluidic channel,
wherein the microfluidic device further comprises at least one second auxiliary inlet for a second auxiliary fluid arranged in the first portion of the microfluidic channel and at least one second valve for controlling a flow rate of the second auxiliary fluid, the second auxiliary inlet being arranged relative to the main inlet and the first auxiliary inlet so as to cause the fluid to be pinched between the first auxiliary fluid and the second auxiliary fluid;
said method comprising:
flowing the first solution comprising the first cell in the microfluidic channel,
causing the first solution to flow at a first height in the microfluidic channel using a flow of the second auxiliary fluid, the first auxiliary inlet being closed, so as to bring the first cell to the first trapping portion,
flowing the second solution comprising the second cell in the microfluidic channel,
causing the second solution to flow at a second height in the microfluidic channel using a flow of the first auxiliary fluid and the second auxiliary fluid pinching the second solution, so as to bring the second cell to the second trapping portion;
flowing a third solution comprising the third cell,
causing the third solution to flow at a third height in the microfluidic channel using a flow of the first auxiliary fluid, the second auxiliary inlet being closed, so as to bring the third cell to the third trapping portion.

14. The method of claim 12, wherein the microfluidic device further comprises an array of electrodes electrically isolated from each other and arranged on the bottom of the microfluidic channel such that an overlapping area of two electrodes is located under each cell trap, at least one surface of each electrode being exposed in a recess formed around said overlapping area, each electrode being connected to an electrical source so as to selectively apply a potential difference to a solution at each overlapping area;
the method further comprising releasing a cell assembly from a selected cell trap by applying, to the electrodes overlapping under the selected cell trap, an electrical potential difference greater than an electrical potential difference triggering electrolysis, dielectrophoresis or electroosmosis of the solution in the respective recess, so as to generate a bubble adapted to push the cell assembly out of the selected cell trap.

15. The method of claim 12, wherein the microfluidic device further comprises at least one pair of electrodes, the electrodes of each pair being electrically isolated from each other and arranged parallel to each other on the bottom of the microfluidic channel such that an area of the pair of electrodes is located under each cell trap, at least one surface of each electrode of the pair of electrodes being exposed in a recess formed around said area of the pair of electrodes, each electrode being connected to an electrical source so as to selectively apply a potential difference to a solution at each area of the pair of electrodes;
the method further comprising releasing a cell assembly from a selected cell trap by applying, to the electrodes of a pair of electrodes under the selected cell trap, an electrical potential difference greater than an electrical potential difference triggering electrolysis, dielectrophoresis or electroosmosis of the solution in the respective recess, so as to generate a bubble adapted to push the cell assembly out of the selected cell trap.

16. A method for selectively treating a first cell and a second cell within a cell assembly, comprising:
forming the cell assembly with the method according to claim 12, the cell assembly comprising at least one first cell located at a first height and at least one second cell located at a second height, different from the first height, relative to the bottom of the microfluidic channel,
flowing an agent into the microfluidic channel though at least one of the main inlet, the first inlet, or, if appropriate, the second inlet,
flowing at least one auxiliary fluid introduced into the microfluidic channel through another one of the main inlet, the first auxiliary inlet, or, if appropriate, the second auxiliary inlet so as to cause the agent to flow at a controlled height in the microfluidic channel to bring the agent to a selected cell within the cell assembly.

17. The method of claim 16 for selectively treating the first cell with a first agent and a second agent, respectively using a microfluidic device comprising:
a microfluidic channel;
at least one main inlet for a fluid among a first solution containing the first cell and a second solution containing the second cell, arranged in a first portion of the microfluidic channel;
an outlet arranged in a second portion of the microfluidic channel for controlling a flow rate of the fluid in the microfluidic channel;
at least one first auxiliary inlet for a first auxiliary fluid arranged in the first portion of the microfluidic channel upstream or downstream of the main inlet;
at least one cell trap arranged in the microfluidic channel between the first portion and the second portion,
wherein each cell trap comprises at least one first trapping portion and one second trapping portion, the first trapping portion being sized to receive a trapped first cell, and the second trapping portion being sized to receive a trapped second cell, said first and second trapping portions being adjacent to each other in a direction perpendicular to a bottom of the microfluidic channel to form the cell assembly with the trapped first and second cells, the trapped first cell being at a different height than the trapped second cell relative to the bottom of the microfluidic channel,
at least one first valve for controlling a flow rate of the first auxiliary fluid so as
to cause the first solution containing the first cells to flow at a first determined height, in the microfluidic channel in order to bring the first cells to the first trapping portion, and
to cause the second solution containing the second cells to flow at a second determined height in the microfluidic channel in order to bring the second cells to the second trapping portion;
at least one second auxiliary inlet for a second auxiliary fluid arranged in the first portion of the microfluidic channel and at least one second valve for controlling a flow rate of the second auxiliary fluid, the second auxiliary inlet being arranged relative to the main inlet and the first auxiliary inlet so as to cause the fluid to be pinched between the first and second auxiliary fluids;
said method comprising:
flowing a buffer through the main inlet,
flowing the first agent through the first auxiliary inlet, the second auxiliary inlet being closed, so as to cause the first agent to flow at a first height in the microfluidic channel to bring the first agent to the first cell;
flowing the second agent through the second auxiliary inlet, the first auxiliary inlet being closed, so as to cause the second agent to flow at a second height in the microfluidic channel to bring the second agent to the second cell.

18. The method of claim 16 for selectively treating the first cell and the second cell with a first agent and a second agent, respectively, using a microfluidic device comprising:
a microfluidic channel;
at least one main inlet for a fluid among a first solution containing the first cell and a second solution containing the second cell, arranged in a first portion of the microfluidic channel;
an outlet arranged in a second portion of the microfluidic channel for controlling a flow rate of the fluid in the microfluidic channel;
at least one first auxiliary inlet for a first auxiliary fluid arranged in the first portion of the microfluidic channel upstream or downstream of the main inlet;
at least one cell trap arranged in the microfluidic channel between the first portion and the second portion,
wherein each cell trap comprises at least one first trapping portion and one second trapping portion, the first trapping portion being sized to receive a trapped first cell, and the second trapping portion being sized to receive a trapped second cell, said first and second trapping portions being adjacent to each other in a direction perpendicular to a bottom of the microfluidic channel to form the cell assembly with the trapped first and second cells, the trapped first cell being at a different height than the trapped second cell relative to the bottom of the microfluidic channel,
at least one first valve for controlling a flow rate of the first auxiliary fluid so as
to cause the first solution containing the first cells to flow at a first determined height, in the microfluidic channel in order to bring the first cells to the first trapping portion, and
to cause the second solution containing the second cells to flow at a second determined height in the microfluidic channel in order to bring the second cells to the second trapping portion:
at least one second auxiliary inlet for a second auxiliary fluid arranged in the first portion of the microfluidic channel and at least one second valve for controlling a flow rate of the second auxiliary fluid, the second auxiliary inlet being arranged relative to the main inlet and the first auxiliary inlet so as to cause the fluid to be pinched between the first and second auxiliary fluids;
said method comprising:
flowing a buffer through the main inlet,
flowing the first agent through the first auxiliary inlet and the second agent through the second auxiliary inlet, so as to concurrently cause the first agent to flow at a first height in the microfluidic channel to bring the first agent to the first cell and cause the second agent to flow at a second height in the microfluidic channel to bring the second agent to the second cell.

19. The method a of claim 16, wherein at least one of the first agent and the second agent has a determined pH and/or a determined viscosity, said pH or viscosity being chosen to simulate cell interaction in a determined situation.
